(19) United States
(12) Patent Application Publication
(10) Pub. No.: US 2020/0122109 A1
(43) Pub. Date: Apr. 23, 2020

(54) SYSTEMS AND METHODS FOR MAINTAINING CHEMISTRY IN MOLTEN SALT SYSTEMS

(71) Applicant: KAIROS POWER LLC, Alameda, CA (US)

(72) Inventors: Alan Kruizenga, Oakland, CA (US); Puru Goyal, Berkeley, CA (US); Michael Hanson, Alameda, CA (US); Augustus Merwin, Alameda, CA (US)

(73) Assignee: KAIROS POWER LLC, ALAMEDA, CA (US)

(21) Appl. No.: 16/654,815

(22) Filed: Oct. 16, 2019

Related U.S. Application Data
(60) Provisional application No. 62/747,038, filed on Oct. 17, 2018.

(51) Int. Cl. B01J 10/00; C25C 5/04; C25C 7/06

(52) U.S. Cl. CPC B01J 10/002; C25C 7/06; C25C 5/04

(57) ABSTRACT

Methods and systems for removing impurities from a molten salt stream are provided. A molten salt stream is provided that comprises a mixture of compounds selected from the group consisting of LiF, BeF₂, and NaF, and ZrF₄. The molten salt stream is flowed through a loop that may contain a precipitation filter, electrochemical potential, and/or a sparger, which thereby remove impurities in the molten salt stream. Various physical methods and apparatus are used to control the ability to remove impurities from the molten salt stream based on temperature, solubility, and general chemistry control.

### FIELD OF THE INVENTION

The invention generally relates to a methods and apparatuses for controlling the amounts of impurities in a molten salt systems. Without controlling the impurities, corrosion can increase and failures in the system may persist. Although there are many physical mechanisms detailed, it could be equally available to use multiple methods or apparatuses disclosed herein to achieve a greater control of impurity removal in a molten salt system.

### BACKGROUND OF THE INVENTION

Molten salt systems contain or accumulate impurities that can result in the corrosion of structural materials. Corrosion of structural materials can increase maintenance costs and downtime for systems that harness molten salt streams as heating or cooling mechanisms. In the present invention, multiple different methods and apparatuses of removing impurities are disclosed which aid in the removal of impurities from molten salt stream systems.

The present disclosure generally relates to nuclear reactor systems that may be heated or cooled using molten salt systems. In particular, the present disclosure relates to methods for removing impurities within molten salt systems. Methods and systems as described herein may be used with nuclear reactor heating or cooling streams, such as molten salt streams. In some embodiments, the molten salt streams may comprise halide-based salts.

### SUMMARY OF THE INVENTION

In some embodiments of the present invention, methods and systems described herein may utilize precipitation or separation of impurities that may occur when a molten salt stream lowers in temperature. Physical mechanisms included in the separation of the molten salt stream may include for example, physical filtration, decreasing solubility to result in phase separation, promoting chemical reactions through oxidation or reduction, induced chemical reactions via introduction of an electrical potential, and gas sparging. Other physical mechanisms may be present as well and would be understood by a person of ordinary skill in the art as well as combining different physical separation mechanisms for additional promotion removal of impurities. By managing the temperature of the molten salt stream and passing the molten salt stream through packed material, such as by passing the molten salt stream through a cold trap, impurities may be separated out. In some embodiments, impurities that have a solidus temperature that is above the temperature of the molten salt stream as it passes through the cold trap will be precipitated out. Additionally, one can precipitate out impurities by decreasing solubility in the molten salt stream to effectively create a phase separation and allow for impurities to be separated from the molten salt stream. Further, the packed material itself that the molten salt stream passes through may be configured to filter and/or react the precipitates of the impurities as the molten salt stream passes through. In some embodiments, the packed material may be at a same temperature as the molten salt stream. In some embodiments, the packed material may be at a lower temperature than the molten salt stream.

In one aspect of the invention, a method of removing impurities from a molten salt stream is provided. The method comprises providing a molten salt stream that comprises a mixture of compounds selected from the group consisting of a LiF compound, a BeF₂ compound, a NaF compound, KF compound, and/or ZrF₄. Additionally, the molten salt stream may also comprise fluorides of the following elements: thorium, uranium, neptunium, and plutonium. Additionally, the method comprises flowing the molten salt stream through a precipitation filter, thereby removing impurities that have a decreased solubility relative to the molten salt stream.

In another aspect of the invention, a method of reacting an amount of elemental Be within a molten salt stream is provided. As elemental Be is reacted in the salt stream, it is consumed and additional elemental Be can be added to maintain concentration at target levels. Thus, the method comprises exposing the molten salt stream to additional amount of Be. Additionally, any of the elemental metals from the group consisting of Li, Na, K, Be, Zr or other equivalent hydride or equivalent compound or alloy of these metals could be used as a reducing agent to control the elemental Be in the salt stream.

In another aspect of the invention, a method of increasing an amount of BeF₂ within a molten salt stream is provided. The method comprises providing the molten salt stream. The method also comprises providing a beryllium-based reducing agent. Additionally, the method comprises exposing the molten salt stream to the beryllium-based reducing agent, thereby increasing the amount of BeF₂ within the molten salt stream. Oxidation and or reduction agents can be used to control the concentration of elemental Be in the molten salt stream. HF is one such example of an oxidizing agent that could be used in this invention, but one skilled in the art would be able to determine other possible oxidizing agents based on each compounds Gibbs free energy requirements.

In another aspect of the invention, a method of increasing a ratio of Zr²⁺/Zr⁴⁺ within a molten salt stream is provided. The method comprises providing the molten salt stream, wherein the molten salt stream has an initial ratio of Zr²⁺/Zr⁴⁺. The method also comprises exposing the molten salt stream to a reducing agent, thereby increase the ratio of Zr²⁺/Zr⁴⁺ to a level that is above the initial ratio of Zr²⁺/Zr⁴⁺.

In another aspect of the invention, a method of decreasing a ratio of Zr²⁺/Zr⁴⁺ within a molten salt stream is provided. The method comprises providing the molten salt stream, wherein the molten salt stream has an initial ratio of Zr²⁺/Zr⁴⁺. The method also comprises exposing the molten salt stream to a oxidizing agent, thereby decreasing the ratio of Zr²⁺/Zr⁴⁺ to a level that is below the initial ratio of Zr²⁺/Zr⁴⁺.

In a further aspect of the invention, a method of controlling a ratio of Zr²⁺/Zr⁴⁺ within a molten salt stream is provided. The method comprises providing the molten salt stream, wherein the molten salt stream has an initial ratio of Zr²⁺/Zr⁴⁺. The method also comprises exposing the molten salt stream to an applied electrical potential that is sufficient to affect the ratio, thereby controlling the ratio of Zr²⁺/Zr⁴⁺ to a level that is a controlled ratio of Zr²⁺/Zr⁴⁺. Controlling the salt potential using Zr metal, can be achieved either by using chemical reduction or electro chemical potential control. Similar to embodiments already described, Zr control can be achieved through decreasing the solubility in the molten salt stream to effectively create a phase separation and allow for impurities to be separated from the molten salt stream. Further elemental Zr can be added to the molten salt stream, and will be consumed to maintain target concentration levels. Any of the additional metals mentioned above can also be added or other equivalent hydride or equivalent compound of these metals to be used as a reactive agent to control the elemental Zr in the salt stream.

Methods to control could include chemical oxidation, chemical reduction or electrochemical chemical potential control.

In a further aspect of the invention, a method of decreasing a ratio of Zr²⁺/Zr⁴⁺ within a molten salt stream is provided. The method comprises providing the molten salt stream, wherein the molten salt stream has an initial ratio of Zr²⁺/Zr⁴⁺. The method also comprises exposing the molten salt stream to an applied potential that is sufficient to decrease the ratio, thereby decreasing the ratio of Zr²⁺/Zr⁴⁺ to a level that is below the initial ratio of Zr²⁺/Zr⁴⁺.

These and other embodiments are described in further detail in the following description related to the appended drawing figures.

### BRIEF DESCRIPTION OF THE DRAWINGS

Specific embodiments of the disclosed device, delivery systems, or methods will now be described with reference to the drawings. Nothing in this detailed description is intended to imply that any particular component, feature, or step is essential to the invention.

FIG. 1 shows a schematic of removing impurities from a molten salt stream by chemical reaction.

FIG. 2 shows a schematic of removing impurities from a molten salt stream by inducing an electrochemical reaction using an electric power supply.

FIGS. 3.1, 3.2, 3.3 and 3.4 show schematics of removing impurities from a molten salt stream by different filtration techniques.

FIG. 4.1 shows a schematic of removing impurities from a molten salt stream by phase separation.

FIG. 4.2 shows a graphical representation of solubility versus temperature.

FIG. 5 shows a schematic of removing impurities from a molten salt stream by gas sparging.

FIG. 6 shows a second representation of removing impurities from a molten salt stream by gas sparging.

### DETAILED DESCRIPTION OF THE INVENTION

Specific embodiments of the disclosed systems and methods of use will now be described with reference to the drawings. Nothing in this detailed description is intended to imply that any particular component, feature, or step is essential to the invention.

Systems and methods disclosed herein are provided for maintaining and controlling chemistry for molten salt systems. In some embodiments, methods and systems as provided herein utilize a cold trap within molten salt systems to remove impurities. In some embodiments, methods and systems may include use of a reducing agent. In some embodiments, a reducing agent may be added at specific temperatures to control an amount that is dissolved into the molten salt stream. In some embodiments, methods and systems that include use of a cold trap as well as a reducing agent may be used to remove impurities.

In particular, molten salt systems may contain impurities that may cause undesired behavior (corrosion, chemical complications, change of physical salt stream properties). Further, impurities within a molten salt stream would decrease in the system as temperature decreases. Accordingly, one way of removing impurities in a molten salt system may be to introduce a reducing agent added to the molten salt stream to remove impurities within the molten salt stream. Another way of removing impurities in a molten salt system may be to induce an electrochemical reaction using an electric power supply. Another way of removing impurities in a molten salt system may be to add a filter to the system. Additionally, another way of removing impurities may be to decrease the temperature of the system while passing a molten salt stream through a cold trap. Another way of removing impurities in a molten salt system may be to introduce a gas sparger to remove impurities from the molten salt system. These processes are discussed herein and may, individual or in tandem, be used to decrease the concentration of impurities within a molten salt stream.

In some embodiments, molten salt systems may utilize halide-based salts. In some embodiments, for example molten salt systems comprised of mixtures of LiF and BeF₂, may be used to heat or cool nuclear reactors. In the embodiments of molten salt system described herein, fluoride salts may have atmospheric impurities (e.g., air, moisture) that result in excessive corrosion of structural materials. In some examples, hydrogen contamination (i.e. moisture ingress) may result in the formation of hydrogen fluoride (HF), which in turn may cause corrosion of alloys containing chromium through the following reaction:

Cr₍ₛ₎+2HF_{(d)}→CrF₂_{_{(d)}}+H₂_{_{(g)}}

In some embodiments, chromium may be selectively oxidized from a solid (s) and/or dissolved constituent (d), while hydrogen may be released as a gas (g). One way to mitigate corrosion is to add a reducing agent that preferentially reacts with contaminants to protect the structural alloys. An example of this is the addition of elemental (i.e. metallic) beryllium which has limited solubility in the molten salt stream:

Be_{(d)}+2HF_{(d)}BeF₂_{_{(d)}}+H₂_{_{(g)}}

Hydrogen may then be liberated as a gas and can be removed through the gas handling portions of the reactor system. BeF₂ formed is consistent with the original molten salt composition, with an impact being a slight increase in BeF₂ concentration within the molten salt. In some embodiments, another impact of BeF₂ formation is a decrease in the elemental Be concentration present within the molten salt.

### Use of Reducing Agent and Chemical Reaction

In some embodiments, other impurities, such as but not limited to oxides, carbides, hydroxides, or metal fluorides may also be removed to maintain a desired chemical composition.

After the precipitation tank the molten salt flow proceeds to a component that adds reducing agent to the melt. Several reducing agents may be used, including the addition of elemental beryllium. Further, periodic additions of elemental beryllium can reduce corrosion in molten salt systems (for example LiF and BeF₂ molten salt systems) by an order of magnitude. Elemental beryllium may be added in several configurations. In some configurations, elemental beryllium may be added in a packed-bed with a BeF₂ containing molten salt flowing over the elemental beryllium (e.g. in a chemistry control branch). In some embodiments, beryllium may be added in periodically either in a main nuclear reactor system or at moving the location of the reducing agent to the exit of the branch loop, which increases the salt temperature and increases solubility.

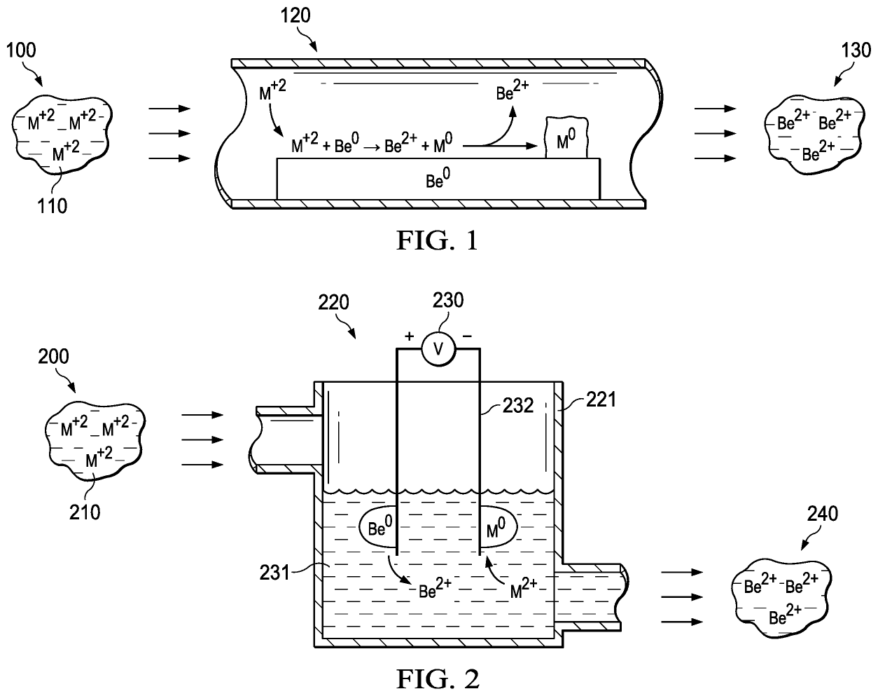

The addition of a reducing agent may be controlled. Additionally, accumulated impurities may be removed. Referring to FIG. 1 a method and system that provides a flow branch may be used for removing impurities and chemically treating a molten salt stream as illustrated. Molten salt stream 100 with metallic impurity M²⁺ 110 enters the flow branch 120. A portion of the metallic impurity 110 chemically reacts with metallic beryllium 121 to reduce the metal impurity to metallic impurity M⁰ 122 and oxidized beryllium Be²⁺ 123. The metallic impurity M⁰ 122 is deposited and clean beryllium salt 130 is passed through the flow branch 120.

In some embodiments, adding elemental beryllium in the purification system may be added to the molten salt stream at the same temperature as the phase separator tank. In some embodiments, this addition of elemental beryllium at the same temperature as the phase separator tank may be preferable as it may ensure that dissolved elemental beryllium precipitates out in the cold trapping process. A clean molten salt stream that comes out from the precipitation volume may then have the beryllium addition included within the clean molten salt stream. Additionally, the clean molten salt stream having the elemental beryllium addition may then go through an economizer to increase temperature before returning to the nuclear reactor system. In some embodiments, an amount of elemental beryllium may be controlled based on the temperature of the molten salt stream. In particular, additional of elemental beryllium in the main nuclear reactor system may be done to augment levels passively obtained in the purification system.

In some embodiments, other reducing and oxidizing agents may also be used in methods and systems described herein may include elemental zirconium or mixtures of ZrF₂/ZrF₄. In some embodiments, metals that may be used include reducing or oxidizing agents and metals.

### Electrochemical Separation

In another embodiment, phase separation may be induced by application of an electrical potential to electrodes in contact with the salt stream to drive oxidation or reduction reactions. Electrodes can promote oxidation of elemental Be to form BeF₂ and to drive the reduction of other constituents in the molten salt stream. Additionally, the application of induced electrical potential can be used to induce or promote reactions that would otherwise not take place due to reaction kinetics. An additional aspect of using electrical potential of electrodes is that electrodes can be used to drive metal constituents towards chemical reactions via application of an electrical potential to more easily promote the metal constituents to increased or reduced oxidation states in order to control the amounts of elemental metal in the molten salt stream.

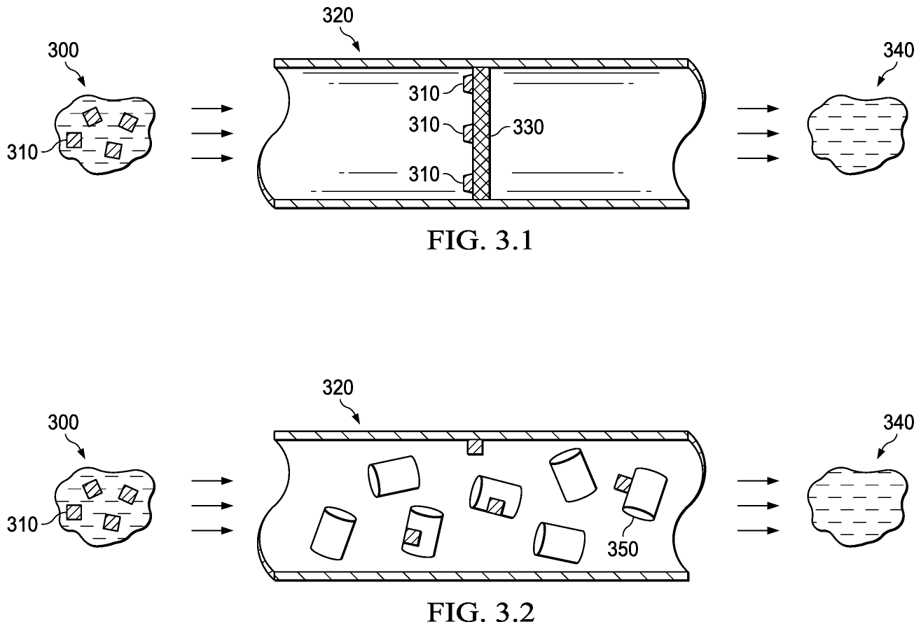

Referring to FIG. 2, a method and apparatus for electrochemical separation is disclosed. Molten salt stream 200 with metallic impurity M⁺² 210 enters the flow branch 220. Molten salt stream 200 enters a flow area 221 that allows for a certain residence time. Metallic impurity M⁺² 210 is removed from the molten salt stream 200 through an electrochemical reaction using an electric power supply 230. In this example in FIG. 2, elemental beryllium (Be) 231 is used as a positively charged anode 232 where it oxidizes to form Be²⁺. A separate, negatively charged electrode 233 is used to reduce the metallic impurity M⁺² 210 to make metallic M⁰. New clean beryllium salt 240 is formed and metallic impurity M⁺² 210 has been removed.

### Filtration

In another set of embodiments, the precipitation volume provides mechanical filtration of impurities. In one embodiment, a cold trap can harness physical or mechanical separation. Through this type of separation, filtration of particulates, solids, gases, or different density phases from the salt stream is achieved based on the physical properties of the constituents of the salt stream.

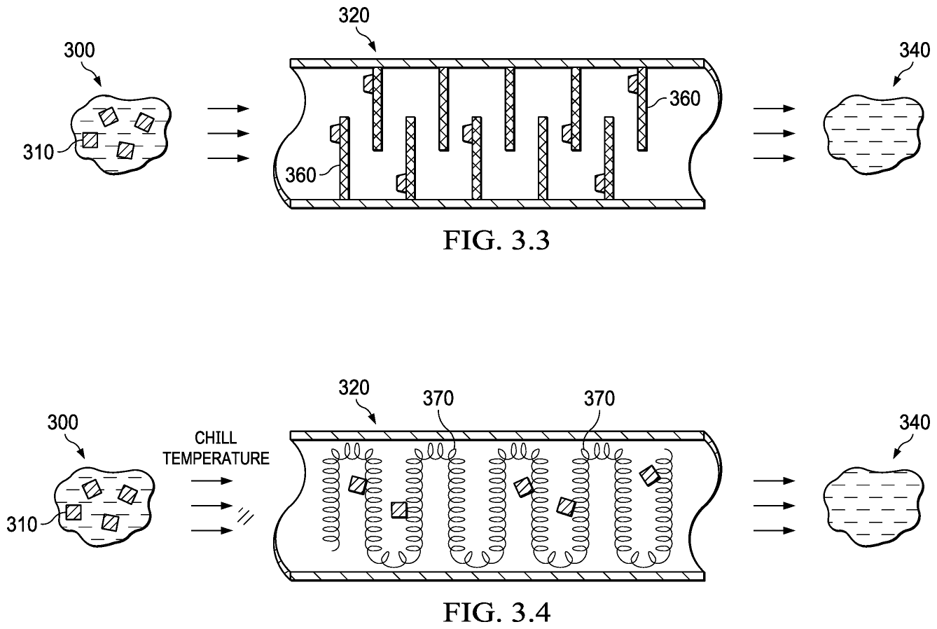

Referring to FIG. 3.1, a method and apparatus for filtering particulates from a molten salt stream 300 is provided. In particular, FIG. 3.1 provides a molten salt stream 300 with impurities 310 entering a flow branch 320. A filter 330 is disposed internal to the flow branch 320 and serves to mechanically filter the impurities 310 from the molten salt stream 300. The molten salt stream 300 is cleaned and exists as clean molten salt stream 340. Referring to FIG. 3.2, the flow branch 320 may have packed media 350 that exists to remove impurities 310. Referring to FIG. 3.3, the flow branch 320 may have a tortious pathway 360 to remove impurities 310. Referring to FIG. 3.4, the flow branch 320 may have high surface area packing 370 to remove impurities. Examples of optional high surface area packing 370 media materials include but are not limited to graphite, stainless steel, and/or a beryllium alloy, such as copper beryllium. In some embodiments, a generic alloy may be used such as carbon steel, stainless steel, a nickel alloy, or a combination of same, in addition to other examples. In some embodiments, a graphite or stainless steel material may be provided as a foam, wool, mesh, and/or packed bed. Various different materials can be used and are not limited to the ones described herein, but would be readily identifiable by a person of ordinary skill in the art.

Additionally, the flow branch 370 may also have a high surface area for removal of impurities, for example, a packed media comprised of stainless-steel wool. Further, use of a beryllium alloy packed media may result in a dual functioning component that simultaneously removes impurities with increased surface area and adds beryllium to the molten salt stream as a reducing agent.

### Use of a Cold Trap and Phase Separation

In some methods and systems, a precipitation volume, which may also be referred to as a cold trap, may be utilized to remove impurities from a molten salt system. In some embodiments, the precipitation volume provides precipitation or phase separation of impurities. In some embodiments, the precipitation volume provides both filtration and precipitation of impurities. The design of the precipitation volume may provide long residence time to facilitate removal of impurities in the molten salt.

Various residence times would be able to be used, depending on the intended results. Any residence time from 30 seconds to more than 4 hours has been observed and one of skill in the art would be able to maximize the residence time based on the intended precipitant volume expected. For example, when removing impurities from a molten salt mixture of a BeF₂ containing molten salt, the residence time of the molten salt may be approximately 15 minutes.

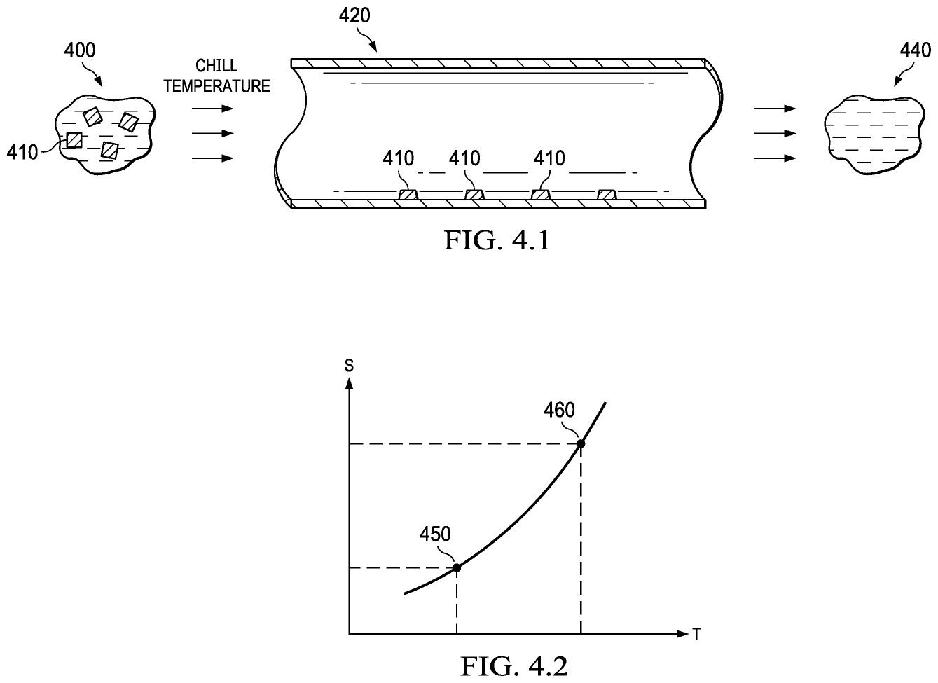

Referring to FIG. 4.1, a molten salt stream 400 containing particulates 410 are chilled to a temperature below operational temperature of the molten salt stream and through a flow branch 420. The flow branch 420 may also be called a cold trap because it is used to create a temperature differential in the salt stream to reduce the solubility of entrained impurities 410 and effectuate phase separation in the flow branch 420 to remove impurities 410 from the molten salt stream. Thus, the clean molten salt stream 440 exists the flow branch 420 after impurities 410 are removed.

In some embodiments, the use of methods and systems described herein may be used to remove several hundred ppm of oxide contaminants. In some embodiments, the use of methods and systems described herein may be used to remove several thousand ppm of oxide contaminants. Additionally, in some embodiments, use of equipment to generate a localized cold surface, such as cold fingers, may be used to remove impurities. In some embodiments, use of cold fingers in NaBF₄ melts may be used to remove chromium. Further, in some embodiments, use of cold fingers in NaBF₄ melts may provide evidence for products other than oxides to be trapped. In some embodiments, noble metals that may be trapped include Ru, Rh, Pd, Ag, Cd, In, and Sn, among other examples of fission products that would be known to a person of ordinary skill in the art. In some embodiments, noble metals may be insoluble. Additionally, in some embodiments, metalloids that may be trapped include Nb, Mo, Tc, Sb, and Te, among other examples. In some embodiments, metalloids may not form volatile products. In some embodiments, corrosion products that may be trapped include Fe, Cr, and Ni, among other examples. In some embodiments, failed fuels such as uranium oxide and carbide, among other examples, may be trapped. In some embodiments, graphite may be trapped. In some embodiments, a cold trap may be designed to generally remove particulate matter. In some embodiments, a cold trap may be designed to remove particulate matter that is above a threshold size. In another embodiment, dissolved gases in the molten salt stream may be removed via lowering their solubility by lowering the temperature of the molten salt stream and promote removal of the gases from the molten salt stream. In some embodiments, impurities that are removed by the cold trap may agglomerate in the cold trap. In some embodiments, elemental Be may be removed using a cold trap.

Referring to FIG. 4.2 solubility of impurities in a molten salt stream are shown to have a direct correlation with temperature of the molten salt stream. FIG. 4.2 shows solubility versus temperature at the lower quadrant 450 where the temperature would be the minimum liquid temperature for the molten salt stream, or chill temp, and the upper quadrant 460 would be the operational temperature of the molten salt stream. In general solubility of oxides, carbides, fluorides, hydroxides, or iodides in a molten salt stream decreases as a temperature decreases, for example, the solubility of compounds may vary from 300 parts per million (ppm) at 650° C. to 70 ppm at 500° C. Conversely, as temperature increases, solubility increases and additional impurities may be dissolved in the molten salt stream. As such, the use of methods and systems described herein may be used to remove oxide contaminants. The residence time of the molten salt stream within the precipitation volume may be achieved by having a large cavity with flow rates set based upon experimentally determined precipitation kinetics of impurities of interest.

In some embodiments, molten salt stream temperature may be reduced with several heat exchangers. In other embodiments, the temperature of the molten salt stream may be reduced so as to achieve a minimum liquid temperature which may be maintained as molten salt streams flow through a phase separator tank or cold trap.

### Separation by Gas Sparging

In another embodiment, removal of particulate matter can be achieved by sparging with the use of inert gas. This mechanism may be known as bubble burst aerosolization and promotes the effective removal of aerosolized particulates carried by the gas stream. Process metals may be removed such as carbon, iron, nickel, chromium, molybdenum, tungsten, copper which all can act as abrasive materials in the salt stream and/or act as a unwanted impurity in the stream. Another example of unwanted material in the salt stream can be fission product in the form of suspended particles, colloids, or mists and removal of these components is necessary to decrease the possibility that the salt stream increases in radioactive activity and could have negative process implications, such as abrasion, corrosion, and other unintended effects the salt stream. Other such particulate matter may be removed in the same manner and would be known to one of ordinary skill.

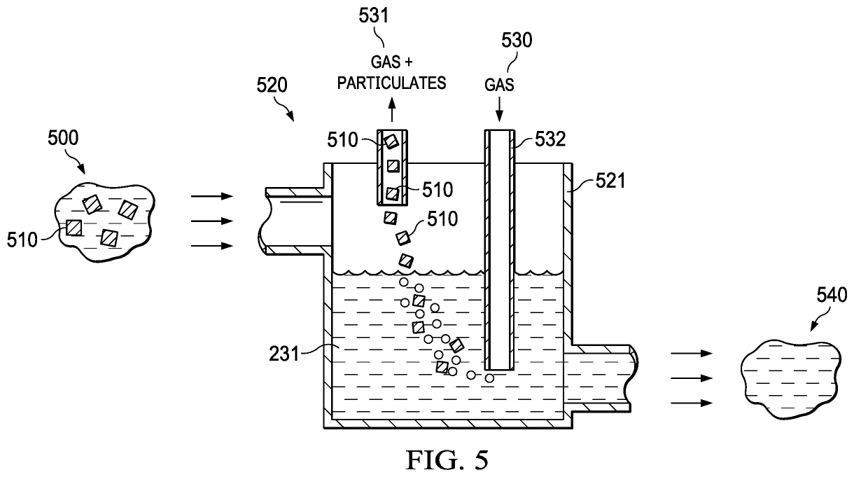

Referring to FIG. 5, molten salt stream 500 and impurities 510 enters the flow branch 520. Molten salt stream 500 with impurities 510 enters a flow area 521 that allows for a certain residence time. Gas inlet 530 allows inert or reactive gas to bubble into the molten salt stream 500 in flow area 521 to create agitation and promote removal of impurities 510 through exhaust manifold 531. Thus, clean molten salt stream 540 exists the flow area 521.

Removal of materials through sparging can be controlled through multiple different methods. One such method could be through temperature control of the sparging gas. Additionally, the gas used with sparging can be either inert or reactive gases. Inert gases promote the effective removal of particulates of different sizes and masses. Reactive gases can be used reduce impurities in the molten salt through a chemical reaction or temperature dependencies. In another embodiment, gas sparging can be done at high and low temperatures to separate entrained gases. Specific unwanted chemicals and simple reaction kinetics to drive additional reactions would be known to one of ordinary skill.

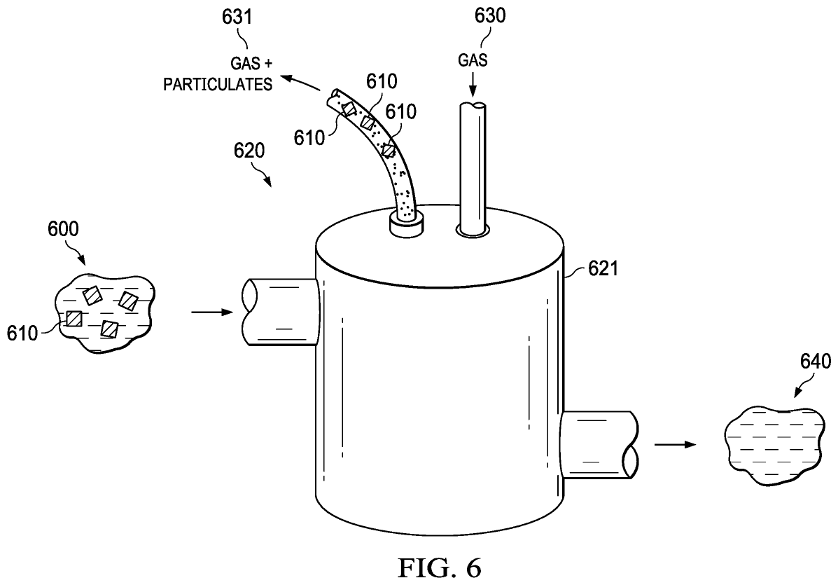

Referring to FIG. 6, another representation of the apparatus for sparging is shown. Molten salt stream 600 and impurities enter flow area 621. Gas inlet 630 allows inert or reactive gases to bubble into the molten salt stream 600 in flow area 621. Exhaust manifold 631 allows for removal of impurities 610 and gas from the molten salt stream 600. Clean molten salt stream 640 exists the flow area 621.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of removing impurities from a molten salt stream, the method comprising:
a. providing a trap to allow residence time in said molten salt stream;
b. said trap having packing media to remove impurities from the molten salt stream.

2. The method of claim 1, wherein the trap comprises a phase separator.

3. The method of claim 2, wherein the trap controls the removal of impurities by controlling temperature of the molten salt stream.

4. The method of claim 2, wherein the trap controls the removal of impurities through controlling chemical potential of the molten salt stream.

5. The method of claim 2, wherein the trap controls the removal of impurities through controlling the electrochemical potential of the molten salt stream.

6. The method of claim 2, wherein the phase separator comprises a vessel with a packed bed, wherein the packed bed is comprised of a beryllium alloy.

7. The method of claim 2, wherein phase separator comprises a vessel with a packed bed, wherein the packed bed is comprised of a lithium alloy.

8. The method of claim 2, wherein the method includes a degassing stream.

9. The method of claim 1, wherein the trap comprises a degasser.

10. The method of claim 9, wherein the trap controls the removal of impurities by controlling temperature of the molten salt stream.

11. The method of claim 9, wherein the trap controls the removal of impurities through controlling chemical potential of the molten salt stream.

12. The method of claim 9, wherein the trap controls the removal of impurities through controlling the electrochemical potential of the molten salt stream.

13. A system for removing impurities from a molten salt stream, the system comprising:
a. A trap for removing impurities in a molten salt stream;
b. A sparger for promoting gas flow through the molten salt stream system; and
c. A vessel for degassing the sparger gas flow.

14. A method of removing impurities from a molten salt stream, the method comprising:
a. Providing a gas sparger for introducing gases to the molten salt stream;
b. Said gas sparger introducing gases to promote removal of impurities in said molten salt stream.

15. The method of claim 14, wherein the introduction of gases promotes bubble burst aerosolization.

16. The method of claim 14, wherein said gases are either inert gases or reactive gases.

17. The method of claim 14, wherein said introduction of gases is done at a controlled temperature.

18. A method of controlling redox potential of a molten salt stream, said method comprising the steps of: introducing a redox agent to the molten salt stream.

19. The method of claim 18, wherein the redox agent can be a dissolved or suspended metal.

20. The method of claim 18, wherein the redox agent can be a multivalent ion.

21. The method of claim 18, wherein a chemical driven change in the redox agent can be controlled by adding a oxidizing agent or a reducing agent.

22. The method of claim 18, wherein the concentration of redox agent is controlled by application of electrical potential to electrodes.

23. A method of increasing an amount of BeF₂ and/or BeO within a molten salt stream, the method comprising:
a. providing the molten salt stream;
b. providing a beryllium-based reducing agent; and
c. exposing the molten salt stream to the beryllium-based reducing agent, thereby increasing the amount of BeF₂ and/or BeO within the molten salt stream.

24. A method of controlling the ratio of Zr²⁺/Zr⁴⁺ within a molten salt stream, the method comprising:
a. providing the molten salt stream, wherein the molten salt stream has an initial ratio of Zr²⁺/Zr⁴⁺; and
b. exposing the molten salt stream to an agent, thereby controlling the ratio of Zr²⁺ in the molten salt stream to control the ratio of Zr²⁺/Zr⁴⁺.

25. The method of claim 24, wherein the method further comprises:
a. exposing the molten salt stream to a reducing agent, thereby increasing the ratio of Zr²⁺ to a level that is above the initial ratio of Zr²⁺ in the molten salt stream to control the ratio of Zr²⁺/Zr⁴⁺.

26. The method of claim 24, wherein the method further comprises:
a. exposing the molten salt stream to a oxidizing agent, thereby decreasing the ratio of Zr²⁺/Zr⁴⁺ to a level that is below the initial ratio of Zr²⁺ in the molten salt stream to control the ratio of Zr²⁺/Zr⁴⁺.

27. The method of claim 24, wherein the method further comprises:
a. exposing the molten salt stream to an applied potential that is sufficient to increase the ratio, thereby increasing the ratio of Zr²⁺ to a level that is above the initial ratio of Zr²⁺ in the molten salt stream to control the ratio of Zr²⁺/Zr⁴⁺.

28. The method of claim 24, wherein the method further comprises:
a. exposing the molten salt stream to an applied potential that is sufficient to decrease the ratio, thereby decreasing the ratio of Zr²⁺ to a level that is below the initial ratio of Zr²⁺ in the molten salt stream to control the ratio of Zr²⁺/Zr⁴⁺.
